(19) United States
(12) Patent Application Publication
(10) Pub. No.: US 2024/0010766 A1
(43) Pub. Date: Jan. 11, 2024

(54) HIGH MELT STRENGTH POLYSTYRENE COMPOSITIONS AND METHODS OF MAKING AND USING SAME

(71) Applicant: Fina Technology, Inc., Houston, TX (US)

(72) Inventors: Tzu-Han LI, Sugar Land, TX (US); Reagan LUCAS, Friendswood, TX (US); Bradley STILES, Houston, TX (US)

(73) Assignee: Fina Technology, Inc., Houston, TX (US)

(21) Appl. No.: 18/348,914

(22) Filed: Jul. 7, 2023

Related U.S. Application Data
(60) Provisional application No. 63/358,878, filed on Jul. 7, 2022.

(51) Int. Cl. C08F 12/08; C08F 2/38; C08K 5/14; C08J 9/00

(52) U.S. Cl. CPC C08F 12/08; C08F 2/38; C08K 5/14; C08J 9/0004; C08J 2325/04

(57) ABSTRACT

A styrenic polymer characterized by a z-average molecular weight of from about 339 kDa to about 520 kDa; a molecular weight distribution of from about 2.5 to about 5.0; a melt strength of from about 0.010 N to about 0.018 N and a melt A method of preparing a styrenic polymer comprising contacting a styrenic monomer, an optional comonomer and an optional initiator to a plurality of temperature environments wherein the difference in temperature between the first environment and the last environment is greater than about 30° C. to form the styrenic polymer; and recovering the styrenic polymer.

### CROSS-REFERENCE TO RELATED APPLICATIONS

This application claims priority to U.S. Provisional Application No. 63/358,878 filed Jul. 7, 2022 entitled “High Melt Strength Polystyrene Compositions and Methods of Making and Using Same,” which is hereby incorporated herein by reference in its entirety for all purposes.

### TECHNICAL FIELD

This disclosure relates generally to polystyrene compositions. More specifically, this disclosure relates to polystyrene compositions having improved melt strength.

### BACKGROUND

Polystyrene compositions, for example foamed polystyrene compositions, are useful in a variety of applications. Foamed polystyrene (PS foam) offers the advantages of low cost, excellent physical properties such as high structural strength and low density. Polystyrene foams produced with blowing agents are commonly used to manufacture a wide array of items such as disposable foam packaging (meat trays, clam shells, etc . . . ). A polystyrene suitable for foaming is characterized by several mechanical properties such as an appropriate melt strength. An ongoing need exists for novel polystyrene compositions having mechanical properties suitable for foaming.

### BRIEF DESCRIPTION OF THE DRAWINGS

For a detailed description of various exemplary embodiments, reference will now be made to the accompanying drawings in which:

FIG. 1 is a schematic of a ROSAND RH7-2 twin-bore capillary rheometer.

FIG. 2 is a graph of the melt strength as a function of melt index for polystyrene compositions of the Examples 1 and 2.

### SUMMARY

Disclosed herein is a styrenic polymer characterized by a z-average molecular weight of from about 339 kDa to about 520 kDa; a molecular weight distribution of from about 2.5 to about 5.0; a melt strength of from about 0.010 N to about 0.018 N and a melt flow index of from about 7.5 g/10 mins to about 9.5 g/10 mins.

Also disclosed herein is a method of preparing a styrenic polymer comprising: subjecting a styrenic monomer, an optional comonomer and an optional initiator to a plurality of temperature environments wherein the difference in temperature between the first environment and the last environment is greater than about 30° C.; and recovering the styrenic polymer.

### DETAILED DESCRIPTION

Disclosed herein are foamed polystyrene compositions having improved melt strength and methods of making and using same. In an aspect, the polystyrene composition is produced utilizing reaction conditions that promote formation of longer polymer chains. In one or more aspects, the polystyrene compositions of the present disclosure display an increased melt strength with a melt flow index (MFI) that is within ±10% of a polystyrene prepared in the absence of a temperature profile of the type disclosed herein. Herein, the polystyrene compositions of the present disclosure characterized by an improved melt strength are designated PS-MS.

In an aspect, the PS-MS comprises a styrene. Styrene, also known as vinyl benzene, ethyenylbenzene and phenylethene is an organic compound represented by the chemical formula C₈H₈. Styrene is widely commercially available and as used herein the term styrene includes a variety of substituted styrenes (e.g., alpha-methyl styrene), ring-substituted styrenes such as p-methylstyrene, disubstituted styrenes such as p-t-butyl styrene as well as unsubstituted styrenes.

In an aspect, styrene is present in the PS-MS an amount of from about 95 wt. % to about 99.99 wt. % weight percent (wt. %), alternatively from about 96 wt. % to about 99.99 wt. % or alternatively from alternatively from about 97 wt. % to about 99.99 wt. % based on the total weight of the PS-MS. Herein the weight percent is based on the total weight of the composition unless indicated. In an aspect, styrene comprises the balance of the PS-MS when all other ingredients are accounted for.

In an aspect, a process for production of the PS-MS comprises contacting the styrenic monomer, an optional comonomer, optionally one or more initiators, and an optional chain transfer agent under conditions suitable for the formation of polystyrene. If used, any initiator capable of free radical formation that facilitates the polymerization of styrene may be employed.

Suitable initiators by way of example and without limitation include organic peroxides. Examples of organic peroxides useful for polymerization initiation include without limitation diacyl peroxides, peroxydicarbonates, monoperoxycarbonates, peroxyketals, peroxyesters, dialkyl peroxides, hydroperoxides, or combinations thereof. The selection of initiator and effective amount will depend on numerous factors (e.g., temperature, reaction time) and can be chosen by one skilled in the art to meet the desired needs of the process. Polymerization initiators and their effective amounts have been described in U.S. Pat. Nos. 6,822,046; 4,861,127; 5,559,162; 4,433,099 and 7,179,873, each of which is hereby incorporated herein by reference herein in its entirety for all purposes. In an alternative aspect, the PS-MS is produced in the absence of an initiator. In yet another aspect, the PS-MS is produced in the absence of a comonomer.

In an aspect, a polymerization reaction to form the PS-MS may be carried out in a solution or mass polymerization process. Mass polymerization, also known as bulk polymerization refers to the polymerization of a monomer in the absence of any medium other than the monomer and a catalyst or polymerization initiator. Solution polymerization refers to a polymerization process in which the monomers and polymerization initiators are dissolved in a non-monomeric liquid solvent at the beginning of the polymerization reaction. The liquid is usually also a solvent for the resulting polymer or copolymer.

The polymerization process can be either batch or continuous. In an aspect, the polymerization reaction may be carried out using a continuous production process in a polymerization apparatus comprising a single reactor or a plurality of reactors. For example, the polymeric composition can be prepared using an upflow reactor.

In one or more aspects, a PS-MS of the present disclosure is prepared in a staged process. Herein the term “stage” refers to a series of actions that can include a ramp up time, a hold time, a hold period or a combination thereof. In one or more aspects of the present disclosure, the stages disclosed herein differ in temperature, ramp up time, hold time or a combination thereof from the processes typically used for production of polystyrene.

In an aspect, a method of producing a PS-MS comprises a first stage wherein a reaction mixture is heated to a first desired temperature (T1), and the reaction mixture is maintained at that temperature for a first hold period (H1). For purposes of this disclosure, the term “ramp up time” refers to a time period over which the temperature is increased and the terms “hold time” and “hold period” are considered interchangeable. Following the first stage the reaction is subjected to a second stage comprising a ramp up time (R2), to a second temperature (T2).

In an aspect, a PS-MS is prepared utilizing a reaction mixture comprising a styrenic monomer, ethylbenzene and organic peroxide where the reaction is carried out by heating to a first temperature, T1, 100° C. to about 135° C., alternatively from about 110° C. to about 130° C., alternatively from about 120° C. for a hold period (H1) of from about 60 to about 360 minutes, alternatively from about 120 to about 360 minutes, or alternatively about 240 minutes.

In one or more aspects, the method for preparation of a PS-MS includes a second stage comprising a temperature ramp time (R2). A second stage of this disclosure may be characterized as being significantly shorter than the first stage. For example, the second stage may comprise R2 wherein the temperature is increased from T1 to T2 about 1 min to about 60 min, alternatively from about 1 min to about 15 min, or alternatively over a time period of about 5 minutes.

In an aspect, the method for preparation of a PS-MS includes a third stage comprising a second desired temperature, T2, 150° C. to about 185° C., alternatively from about 150° C. to about 177° C., alternatively from about 155° C. for a second hold period (H2) of from about 5 to about 120 minutes alternatively from about 60 to about 120 minutes, or alternatively from about 100 to about 110 minutes. Collectively, the disclosed temperatures, hold periods and ramp times are termed the temperature profile of the polymerization reaction.

In an aspect, a chain transfer agent is introduced to the reaction mixture at the temperature ramp (R2). Any chain transfer agent suitable for production of lower molecular weight polymer may be introduced to the reaction mixture. In an aspect the chain transfer agent is a mercaptan. Nonlimiting examples of chain transfer agents suitable for use in the present disclosure include n-octyl mercaptan, t-octyl mercaptan, n-dodecyl mercaptan (NDM), t-dodecyl mercaptan, tridecyl mercaptan, tetradecyl mercaptan, n-hexadecyl mercaptan, n-decyl mercaptan, t-nonyl mercaptan, ethyl mercaptan, isopropyl mercaptan, t-butyl mercaptan, cyclohexyl mercaptan, benzyl mercaptan and combinations thereof. In one or more aspects, the chain transfer agent is NDM.

The chain transfer agent may be introduced to the reaction mixture in an amount of from about 2400 ppm to about 3000 ppm. The total time for the second stage may be monitored so as to coincide with the formation of about 70% solids and the chain transfer agent may be introduced at any point during the second stage. In some aspects, the chain transfer agent is introduced at the initiation of the second. The resulting material is a PS-MS.

In one or more aspects, a method of preparing the PS-MS may comprise subjecting the reaction mixture to a plurality of environments (n) where the first environment n₁ has a temperature T₁, and each subsequent environment has a temperature that is increased such that n₁₊ₓ has a temperature that is increased T_{1+y} where x is equal to or greater than 1, alternatively x is from 1 to 10, alternatively x is from 1 to 8, or alternatively x is from 1 to 4 and y is greater than about 30° C., alternatively y is from about 35° C. to about 70° C. or alternatively y is from about 50° C. to about 60° C. In one or more aspects, the reaction mixture during reaction is subjected to a change in temperature, termed delta, that is greater than about 30, alternatively from about 35 to about 70 or alternatively from about to about 60. In one or more aspects, the environment comprises a reactor.

In one or more aspects, the reaction mixture comprises less than about 5% of an initiator based on the total weight of the reaction mixture, alternatively less than about 4%, 3%, 2%, or 1%. In an alternative aspect, the reaction mixture exudes an initiator. In another aspect, the reaction mixture comprises less than about 10% of a chain transfer agent based on the total weight of the reaction mixture, alternatively less than about 4%, 3%, 2%, or 1%. In an alternative aspect, the reaction mixture exudes a chain transfer agent.

In one or more aspects, a PS-MS of the type disclosed herein is characterized by a weight average molecular weight (M_{w}) of from about 190 kDa to about 250 kDa, alternatively from about 200 kiloDalton (kDa) to about 237 kDa or alternatively from about 210 kDa to about 237 kDa. The Mw describes the weight-average molecular weight of a polymer and can be calculated according to Equation 1:

$${M}_{w} = \frac{{Σ}_{i} {N}_{i} {M}_{i}^{2}}{{Σ}_{i} {N}_{i} {M}_{i}} \qquad ( 1 )$$

wherein Nᵢ is the number of molecules of molecular weight Mᵢ. All molecular weight averages are expressed in gram per mole (kg/mol).

In an aspect, the PS-MS is characterized by a number average molecular weight (Mₙ) of from about 50 kDa to about 80 kDa, alternatively from about 50 kDa to about 72 kDa, or alternatively from about 53 kDa to about 63 kDa. The Mn is the number-average molecular weight of the individual polymers and was calculated by measuring the molecular weight Mᵢ of Nᵢ polymer molecules, summing the weights, and dividing by the total number of polymer molecules, according to equation 2:

$${M}_{n} = \frac{{Σ}_{i} {N}_{i} {M}_{i}}{{Σ}_{i} {N}_{i}} \qquad ( 2 )$$

wherein Nᵢ is the number of molecules of molecular weight Mᵢ.

In an aspect, PS-MS has a z-average molecular weight (M_{z}) of from about 339 kDa to about 520 kDa, alternatively from about 375 kDa to about 510 kDa or alternatively from about 400 kDa to about 510 kDa. The MZ is a higher order molecular weight average which was calculated according to equation 3:

$${M}_{z} = \frac{{Σ}_{i} {N}_{i} {M}_{i}^{3}}{{Σ}_{i} {N}_{i} {M}_{i}^{2}} \qquad ( 3 )$$

wherein Nᵢ is the number of molecules of molecular weight Mᵢ.

In an aspect, the PS-MS has a molecular weight distribution (MWD) which is the ratio of the M_{w} to the Mₙ (M_{w}/Mₙ), (also referred to as the polydispersity index (PDI)) of from about 3.6 to about 4.4, alternatively from about 3.0 to about 4.4, or alternatively from about 2.5 to about 5.0.

In an aspect, the PS-MS may also comprise additives as deemed necessary to impart desired physical properties. Examples of additives include without limitation talc, antioxidants, UV stabilizers, lubricants, mineral oil, plasticizers, and the like. The aforementioned additives may be used either singularly or in combination to form various formulations of the composition. For example, stabilizers or stabilization agents may be employed to help protect the polymeric composition from degradation due to exposure to excessive temperatures and/or ultraviolet light. These additives may be included in amounts effective to impart the desired properties. Effective additive amounts and processes for inclusion of these additives to polymeric compositions are known to one skilled in the art. For example, one or more additives may be added after recovery of the PS-MS, for example during compounding such as pelletization. Alternatively, such additives may be added during formation of the PS-MS or to one or more other components of the PS-MS. In an aspect, additives, either singularly or in combination may be introduced to the PS-MS in amounts ranging from about 0 ppm to about 5000 ppm, alternatively from about 0 ppm to about 2500 ppm, or alternatively from about 0 ppm to about 1000 ppm.

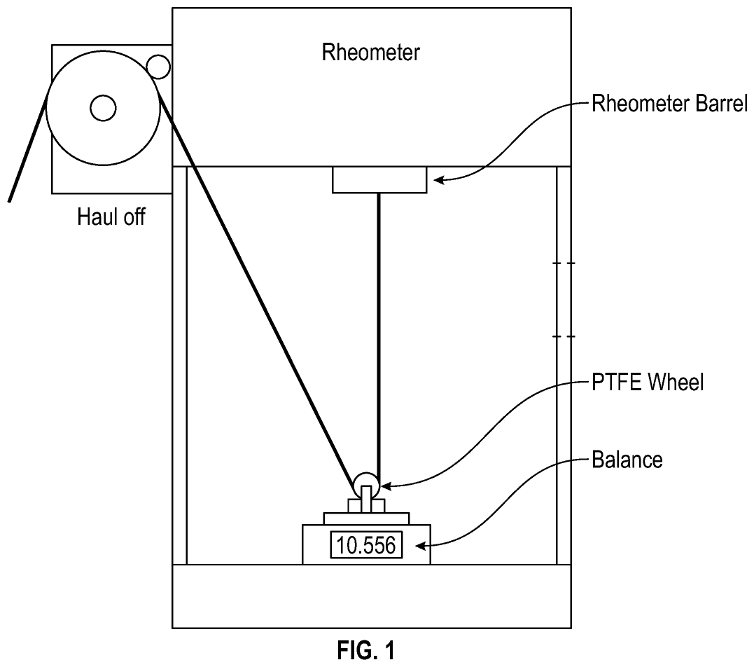

In an aspect, the PS-MS may be characterized by an increased melt strength. Melt strength analysis is a measurement of the extensional viscosity. In an aspect, the melt strength as determined herein employed a method using a ROSAND RH7-2 twin-bore capillary rheometer, with a haul-off apparatus as schematized in FIG. 1. Referring to FIG. 1, polymer may be extruded from the rheometer at a temperature of about 225° C. The polymer melt is then extended by the haul-off apparatus using a continuous ramp sweep from about 5 mm/min to about 300 mm/min over about 5 minutes and the force exerted on the polymer is registered by the analytical balance.

The melt strength value refers to the maximum tension, in Newtons, that can be applied to a melt strand without breaking. In an aspect, a PS-MS of the present disclosure may display a melt strength in the range of from about 0.01 N to about 0.018 N, alternatively from about 0.01 N to about 0.016 N, or alternatively from about 0.013 N to about 0.016 N.

In an aspect, the PS-MS is characterized by a melt flow index comparable to an otherwise similar polystyrene prepared utilizing a different temperature profile. The melt flow index (MFI) is a measure of the ease of flow of the melt of a thermoplastic polymer and is defined as the weight of polymer in grams flowing in 10 min through a die of specific diameter and length by a pressure applied by a given weight at a given temperature. For example, the PS-MS may have a MFI ranging from about 8.0 g/10 min to about 9.0 g/10 min or from about 7.5 g/10 min to about 9.5 g/10 min as determined in accordance with ASTM D-1238.

The PS-MS of the present disclosure is advantageously characterized by a melt strength sufficient to support foaming with a concomitant change in the MFI that is less than or equal to or about 5 g/10 min., alternatively equal to or less than about 2.5 g/10 min., alternatively equal to or less than about 1 g/10 min., or alternatively from about 0 g/10 min. to about 5 g/10 min. This is a surprisingly advantageous feature of the disclosed PS-MS compositions which has a melt strength high enough for foaming without a substantive change in the melt index. Consequently, the PS-MS displays desired levels of end article strength and processability. For example, the PS-MS of the present disclosure may display a melt strength in range of from about 0.013 N to about 0.016 N and a MFI of from about 8.0 g/10 min to about 9.0 g/10 min or alternatively from about 7.5 g/10 min to about 9.5 g/10 min.

Without wishing to be limited by theory, the presence of both characteristics (high melt strength and desirable melt index) in the PS-MS of the present disclosure allows for the unique stability of these materials to foaming. In one or more aspects of the present disclosure, the PS-MS is characterized by a melt strength that is increased by equal to or greater than about 10% and the melt flow index is within ±10% of the melt index of an otherwise similar polystyrene produced utilizing a different temperature profile.

The PS-MS of this disclosure may be foamed and converted to articles by any suitable method. The articles may be produced about concurrently with the mixing and/or foaming of the PS-MS (e.g., on a sequential, integrated process line) or may be produced subsequent to mixing and/or foaming of the PS-MS (e.g., on a separate process line such as an end use compounding and/or thermoforming line). In an aspect, the PS-MS is mixed and foamed via extrusion or compounding as described herein, and the molten PS-MS is fed to a shaping process (e.g., mold, die, lay down bar, etc.) where the PS-MS is shaped. The foaming of the PS-MS may occur prior to, during, or subsequent to the shaping.

In an aspect, molten PS-MS is injected into a mold, where the PS-MS undergoes foaming and fills the mold to form a shaped article. In an aspect, the PS-MS is formed into a sheet, which is then subjected to further processing steps such as thermoforming to produce an article. Examples of articles into which the PS-MS may be formed include, without limitation, food packaging; office supplies; plastic lumber or replacement lumber; patio decking; structural supports; laminate flooring compositions; polymeric foam substrate and decorative surfaces such as crown molding; weatherable outdoor materials; point-of-purchase signs and displays; housewares and consumer goods; building insulation; cosmetics packaging; outdoor replacement materials; and so forth. Additional articles would be apparent to those skilled in the art.

### ADDITIONAL DISCLOSURE

The following enumerated aspects of the present disclosures are provided as non-limiting examples.

A first aspect which is a styrenic polymer characterized by a z-average molecular weight of from about 339 kDa to about 520 kDa; a molecular weight distribution of from about 2.5 to about 5.0; a melt strength of from about 0.010 N to about 0.018 N and a melt flow index of from about 7.5 g/10 mins to about 9.5 g/10 mins.

A second aspect which is the styrenic polymer of claim 1 wherein the melt strength is from about 0.010 N to about 0.016 Nat a z-average molecular weight of from greater than about 339 kDa to about 520 kDa.

A third aspect which is the styrenic polymer of any of claims 1 through 2 having a weight average molecular weight of from about 190 kg/mol to about 250 kg/mol.

A fourth aspect which is the styrenic polymer of any of claims 1 through 3 having a number average molecular weight of from about 53 kg/mol to about 76 kg/mol.

A fifth aspect which is the styrenic polymer of any of claims 1 through 4 further comprising a blowing agent.

A sixth aspect which is a method of preparing a styrenic polymer comprising: subjecting a styrenic monomer, an optional comonomer and an optional initiator to a plurality of temperature environments wherein the difference in temperature between the first environment and the last environment is greater than about 30° C.; and recovering the styrenic polymer.

A seventh aspect which is the method of the sixth aspect wherein the styrenic monomer comprises unsubstituted styrenes, substituted styrenes, ring-substituted styrenes, disubstituted styrenes or combinations thereof.

An eighth aspect which is the method of any of the sixth through seventh aspects wherein the styrenic monomer is present in an amount of from about 95 wt. % to about 99.99 wt. % based on the total weight of the styrenic polymer.

A ninth aspect which is the method of any of the sixth through eighth aspect wherein the optional initiator comprises an organic peroxide.

A tenth aspect which is the method of any of the sixth through ninth aspects wherein the organic peroxide comprises diacyl peroxides, peroxydicarbonates, monoperoxycarbonates, peroxyketals, peroxyesters, dialkyl peroxides, hydroperoxides, or combinations thereof.

An eleventh aspect which is the method of any of the sixth through tenth aspects wherein the first reaction mixture further comprises an optional chain transfer agent.

A twelfth aspect which is the method of the eleventh aspect wherein the chain transfer agent comprises a mercaptan.

A thirteenth aspect which is the method of the twelfth aspect wherein the chain transfer agent comprises n-octyl mercaptan, t-octyl mercaptan, n-dodecyl mercaptan (NDM), t-dodecyl mercaptan, tridecyl mercaptan, tetradecyl mercaptan, n-hexadecyl mercaptan, n-decyl mercaptan, t-nonyl mercaptan, ethyl mercaptan, isopropyl mercaptan, t-butyl mercaptan, cyclohexyl mercaptan, benzyl mercaptan and combinations thereof.

A fourteenth aspect which is the method of any of the sixth through thirteenth aspects wherein the chain transfer agent is present in an amount of from about 0 ppm to about 5000 ppm.

A fifteenth aspect which is the method of any of the sixth through fourteenth aspects wherein the recovered styrenic polymer is characterized by z-average molecular weight of from about 339 kDa to about 520 kDa; a molecular weight distribution of from about 2.5 to about 5.0; a melt strength of from about 0.010 N to about 0.018 N and a melt flow index of from about 7.5 g/10 min. to about 9.5 g/10 min.

A sixteenth aspect which is the method of the fifteenth aspect wherein the melt strength of the styrenic polymer increases by from about 0.010 N to about 0.016 N with a concomitant change in melt flow index of less than about 1 g/10 mins.

A seventeenth aspect which is the method of the fifteenth aspect wherein the molecular weight distribution of the styrenic polymer is broadened by from about 2.5 to about 5.0 when compared to an otherwise similar styrenic polymer is subjected to a change in temperature of greater than about 30°.

An eighteenth aspect which is the method of any of the sixth through seventeenth aspects further comprising foaming the recovered styrenic polymer.

A nineteenth aspect which is the method of any of the sixth through eighteenth aspects, wherein the plurality of temperature environments comprise one or more reactors.

A twentieth aspect which is an end-use article prepared from the foamed styrenic polymer.

### EXAMPLES

The aspects having been generally described, the following examples are given as particular aspects of the disclosure and to demonstrate the practice and advantages thereof. It is understood that the examples are given by way of illustration and are not intended to limit the specification of the claims in any manner.

### Example 1

A PS-MS of the type disclosed herein was prepared and its material properties were evaluated. A base polystyrene composition, designated REF was compared to the PS-MS compositions produced. Notably, the REF sample had low melt strength, limiting its utility in foaming applications. A PS-MS was prepared using a two-step temperature ramp to create crystal polystyrene with a broad molecular weight distribution. The addition of n-dodecyl mercaptan (NDM), a chain transfer agent, after the initial temperature hold period also facilitated the broadening. Two different runs were carried out using differing amounts of NDM. Specifically, NDM was introduced during ramping at amounts of 2698 ppm and 2429 ppm. Both samples exhibited higher MZ and lower Mn when compared to REF samples and displayed higher melt strengths and MFIs like the reference samples. The specific sample compositions for the indicated approaches are provided in Tables 1 and 2 while the temperature/conversion profile for the for the reference sample (REF) is presented in tabular form in Table 3. The molecular weight characteristics of the samples are presented in Table 4.

### Approach 1

TABLE 1

| | | LUPEROX | | |
|---|---|---|---|---|
| | Temperature | L531M80 | NDM Chain | Conversion |
| Time (min) | (° C.) | Initiator | Transfer Agent | (%) |
| 0 | 120 | 107 ppm | | 0 |
| 240 | 120 | | 2698 ppm | 45 |
| 250 | 155 | | | |
| 350 | 155 | | | 69 |

### Approach 2

TABLE 2

| | | LUPEROX | | |
|---|---|---|---|---|
| | Temperature | JWEB50 | NDM Chain | Conversion |
| Time (min) | (° C.) | Initiator | Transfer Agent | (%) |
| 0 | 120 | 115 ppm | | |
| 240 | 120 | | 2429 ppm | 37 |
| 250 | 155 | | | |
| 340 | 155 | | | 67 |

TABLE 3

| Time | | Temperature |
|---|---|---|
| (min) | Conversion(%) | (C.) |
| 0 | 0 | 135 |
| 90 | 57 | 135 |
| 95 | | 145 |
| 120 | 59 | 145 |
| 155 | | 145 |
| 160 | | 155 |
| 190 | 74 | 155 |

TABLE 4
LUPEROX polymer initiator is an organic peroxide
commercially available from Arkema.

| | MFI | Melt | | | | |
|---|---|---|---|---|---|---|
| | (g/ | strength | Mₙ | M_{w} | M_{z} | |
| Sample | 10 min) | (N) | (kg/mol) | (kg/mol) | (kg/mol) | PDI |
| REF | 8.4 | 0.0102 | 76 | 194 | 338 | 2.5 |
| Approach 1 | 7.9 | 0.0141 | 60 | 217 | 408 | 3.6 |
| Approach 2 | 8.8 | 0.0136 | 58 | 217 | 421 | 3.7 |

### Example 2

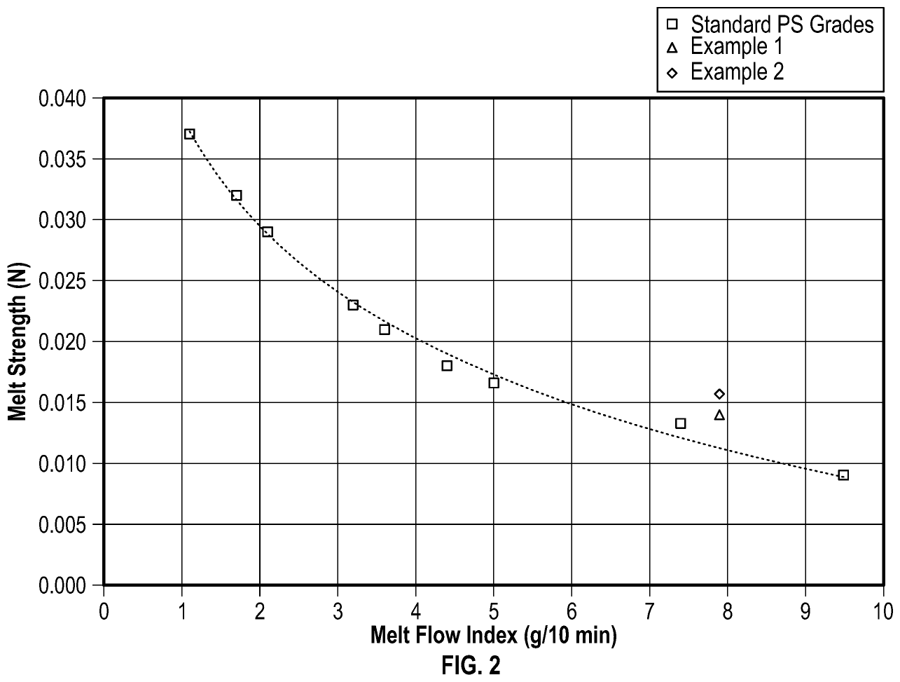

A PS-MS of the type disclosed herein was prepared and its material properties were evaluated. The PS-MS samples were prepared by introducing a reaction mixture comprising a styrenic monomer to a plurality of reactors ranging in temperature from 121° C. to 177° C. The data in Table 5 indicate a PS-MS of the type disclosed herein when subjected to a increased change in temperature had an increased PDI when compared to the reference sample which was subjected to a decreased temperature range. The results are also depicted in FIG. 2.

TABLE 5

| | | | | | | | T_{final} | |
|---|---|---|---|---|---|---|---|---|
| | MFI | Melt | Mₙ | M_{w} | M_{z} | | − | |
| | (g/10 | strength | (kg/ | (kg/ | (kg/ | | Tᵢₙᵢₜᵢₐₗ | Residence |
| Sample | min) | (N) | mol) | mol) | mol) | PDI | (° C.) | time (min) |
| Plant − | 7.4 | 0.013 | 69 | 233 | 448 | 3.4 | 45 | 377 |
| baseline | | | | | | | | |
| PS-MS | 7.9 | 0.016 | 56 | 237 | 498 | 4.2 | 56 | 419 |

In conclusion, the new formulations disclosed herein create polystyrene with high MZ and low Mn, allowed improvement of melt strength at a constant MFI. This is a surprisingly unexpected benefit of the presently disclosed styrenic polymers (i.e., PS-MS).

While various aspects have been shown and described, modifications thereof can be made by one skilled in the art without departing from the spirit and teachings of the disclosure. The aspects described herein are exemplary only, and are not intended to be limiting. Many variations and modifications of the aspects disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the aspects disclosed herein. The discussion of a reference herein is not an admission that it is prior art to the present disclosure, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A styrenic polymer characterized by a z-average molecular weight of from about 339 kDa to about 520 kDa; a molecular weight distribution of from about 2.5 to about 5.0;
a melt strength of from about 0.010 N to about 0.018 N and a melt flow index of from about 7.5 g/10 mins to about 9.5 g/10 mins.

2. The polymer of claim 1, wherein the melt strength is from about 0.010 N to about 0.016 Nat a z-average molecular weight of from greater than about 339 kDa to about 520 kDa.

3. The polymer of claim 1, having a weight average molecular weight of from about 190 kg/mol to about 250 kg/mol.

4. The polymer of claim 1, having a number average molecular weight of from about 53 kg/mol to about 76 kg/mol.

5. The polymer of claim 1, further comprising a blowing agent.

6. A method of preparing a styrenic polymer comprising:
subjecting a styrenic monomer, an optional comonomer and an optional initiator to a plurality of temperature environments wherein the difference in temperature between the first environment and the last environment is greater than about 30° C.;
and recovering the styrenic polymer.

7. The method of claim 6, wherein the styrenic monomer comprises unsubstituted styrenes, substituted styrenes, ring-substituted styrenes, disubstituted styrenes or combinations thereof.

8. The method of claim 6, wherein the styrenic monomer is present in an amount of from about 95 wt. % to about 99.99 wt. % based on the total weight of the styrenic polymer.

9. The method of claim 6, wherein the optional initiator comprises an organic peroxide.

10. The method of claim 9, wherein the organic peroxide comprises diacyl peroxides, peroxydicarbonates, monoperoxycarbonates, peroxyketals, peroxyesters, dialkyl peroxides, hydroperoxides, or combinations thereof.

11. The method of claim 6, wherein the first reaction mixture further comprises an optional chain transfer agent.

12. The method of claim 11, wherein the chain transfer agent comprises a mercaptan.

13. The method of claim 12, wherein the chain transfer agent comprises n-octyl mercaptan, t-octyl mercaptan, n-dodecyl mercaptan (NDM), t-dodecyl mercaptan, tridecyl mercaptan, tetradecyl mercaptan, n-hexadecyl mercaptan, n-decyl mercaptan, t-nonyl mercaptan, ethyl mercaptan, isopropyl mercaptan, t-butyl mercaptan, cyclohexyl mercaptan, benzyl mercaptan and combinations thereof.

14. The method of claim 11, wherein the chain transfer agent is present in an amount of from about 0 ppm to about 5000 ppm.

15. The method of claim 6, wherein the recovered styremic polymer is characterized by z-average molecular weight of from about 339 kDa to about 520 kDa; a molecular weight distribution of from about 2.5 to about 5.0; a melt strength of from about 0.010 N to about 0.018 N and a melt flow index of from about 7.5 g/10 min. to about 9.5 g/10 min.

16. The method of claim 15, wherein the melt strength of the styrenic polymer increases by from about 0.010 N to about 0.016 N with a concomitant change in melt flow index of less than about 1 g/10 mins.

17. The method of claim 15, wherein the molecular weight distribution of the styrenic polymer is broadened by from about 2.5 to about 5.0 when compared to an otherwise similar styrenic polymer prepared in the absence of a broad temperature range and sufficient hold time at each temperature range.

18. The method of claim 6, further comprising foaming the recovered styrenic polymer.

19. The method of claim 17, wherein the plurality of temperature environments comprise one or more reactors. An end-use article prepared from the foamed styrenic polymer.
